(19) United States
(12) Patent Application Publication
(10) Pub. No.: US 2018/0338328 A1
(43) Pub. Date: Nov. 22, 2018

(54) SYSTEMS AND METHODS FOR EARLY COLLISION DETECTION IN ENHANCED LTE/5G NR RANDOM ACCESS

(71) Applicant: Sharp Laboratories of America, Inc., Camas, WA (US)

(72) Inventors: Kamel M. Shaheen, Camas, WA (US); Atsushi Ishii, Vancouver, WA (US)

(21) Appl. No.: 15/981,136

(22) Filed: May 16, 2018

Related U.S. Application Data
(63) Continuation of application No. PCT/US2018/032776, filed on May 15, 2018.
(60) Provisional application No. 62/507,777, filed on May 17, 2017.

(51) Int. Cl. H04W 74/08; H04W 72/14

(52) U.S. Cl. CPC H04W 74/0858; H04W 72/14

(57) ABSTRACT

A base station is described. The base station includes a processor and memory in electronic communication with the processor. Instructions stored in the memory are executable to receive multiple Contention Based Random Access (CBRA) requests on a Physical Random Access Channel (PRACH) and detect a collision based on the receiving of multiple collision detection (CD) codes associated with a single preamble. The UE includes a processor and memory in electronic communication with the processor. Instructions stored in the memory are executable to send a collision detection (CD) code with a preamble in an access request message of a Contention Based Random Access (CBRA) procedure.

### RELATED APPLICATIONS

This application is related to and claims priority from U.S. Provisional Patent Application No. 62/507,777, entitled “SYSTEMS AND METHODS FOR EARLY COLLISION DETECTION IN ENHANCED LTE/5G NR RANDOM ACCESS,” filed on May 17, 2017, which is hereby incorporated by reference herein, in its entirety.

### TECHNICAL FIELD

The present disclosure relates generally to communication systems. More specifically, the present disclosure relates to systems and methods for early collision detection in enhanced long term evolution (LTE)/5G New Radio (NR) random access.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more base stations and one or more user equipments (UEs) in which systems and methods for early collision detection in enhanced long term evolution (LTE)/5G New Radio (NR) random access may be implemented;

FIG. 2 is a flow diagram illustrating an example of a method for performing a contention-based random access (CBRA) procedure by a UE;

FIG. 3 is a flow diagram illustrating an example of a method for performing a CBRA procedure by a base station;

FIG. 4 is a diagram illustrating an example of a contention-based random access procedure;

FIG. 5 is a diagram illustrating an example of a CBRA procedure in accordance with some approaches of the systems and methods disclosed herein;

FIG. 6 is an example of a message structure that may be utilized in some implementations of the systems and methods disclosed herein;

FIG. 7 is a diagram illustrating one example of a resource grid for the uplink;

FIG. 8 is a block diagram illustrating one implementation of a base station;

FIG. 9 is a block diagram illustrating one implementation of a UE;

FIG. 10 illustrates various components that may be utilized in a UE;

FIG. 11 illustrates various components that may be utilized in a base station;

FIG. 12 is a block diagram illustrating one implementation of a UE in which systems and methods for collision based random access may be implemented; and

FIG. 13 is a block diagram illustrating one implementation of a base station in which systems and methods for collision based random access may be implemented.

### DETAILED DESCRIPTION

A base station is described. The base station includes a processor and memory in electronic communication with the processor. Instructions stored in the memory are executable to receive multiple Contention Based Random Access (CBRA) requests on a Physical Random Access Channel (PRACH) and detect a collision based on the receiving of multiple collision detection (CD) codes associated with a single preamble.

The instructions may be executable to determine a number of colliding user equipments (UEs) based on a number of 1's values in the CD codes received in the multiple CBRA requests. The instructions may be executable to allocate a number of grants in a message 2 (Msg2) based on the number of 1's values in the CD codes. The instructions may be further executable to assign the received CD codes to each of the allocated grants. The instructions may be further executable to allocate grants without assigning associated CD codes for each grant.

The multiple CBRA requests may be received in message 1s (Msg1s). The base station may be an evolved Node B (eNB) or a 5G new radio (NR) gNB.

A user equipment (UE) is also described. The UE includes a processor and memory in electronic communication with the processor. Instructions stored in the memory are executable to send a collision detection (CD) code with a preamble in an access request message of a Contention Based Random Access (CBRA) procedure. The message may be a message 1.

The instructions may be executable to randomly select a preamble and randomly select the CD code to be transmitted in the CBRA request. The instructions may be executable to receive multiple grants in a Random Access Response (message 2) and randomly select one of the multiple grants if there is no associated CD code present.

The instructions may be executable to receive multiple grants in a Random Access Response (message 2). Each grant may be associated with a CD code that has been received by a base station in a CBRA request. The instructions may be executable to select a grant that is associated with a CD code that was sent by the UE in the CBRA request and use the resources provided (e.g., indicated) in the received grant to send a message 3.

A method to perform collision detection by a base station in a Contention Based Random Access (CBRA) procedure is also described. The method includes performing collision detection at a first stage (stage 1) (rather than stage 4) based on the received combination of collision detection (CD) codes sent by colliding UEs. The method also includes determining a number of colliding user equipments (UEs) based on the number of 1's in the received CD code. The method further includes allocating a corresponding number of grants based on the determination of the number of colliding UEs.

A method for indicating collision detection by a user equipment (UE) in a Contention Based Random Access (CBRA) (e.g., in a Long Term Evolution (LTE) based CBRA) is also described. The method includes randomly selecting a collision detection (CD) code to be transmitted with the randomly selected preamble in a CBRA request (message 1). The method also includes receiving multiple grants in a Random Access Response (e.g., message 2). Each grant is associated with a CD code, where one of the CD codes corresponds to the CD code that has been sent in the CBRA request. The method further includes selecting a grant that is associated with the CD code that was sent by the UE in the CBRA request. The method additionally includes using the grant in sending a message 3.

A method for indicating collision detection by a user equipment (UE) in a Contention Based Random Access (CBRA) (e.g., in a Long Term Evolution (LTE) based CBRA) is also described. The method includes randomly selecting a collision detection (CD) code to be transmitted with the randomly selected preamble in a CBRA request (message 1). The method also includes receiving multiple grants in a Random Access Response (message 2), wherein each grant is associated with a CD code. One of the CD codes corresponds to the CD code that has been sent in the CBRA request. The method further includes performing back-off procedures (e.g., random delay) if the transmitted CD code that was sent by the UE in the CBRA request does not match any of the associated CD codes included in the message 2. The method may additionally include performing one or more of the previously described CBRA procedures.

A CBRA based access code may include a combination of a randomly selected preamble and a randomly selected collision detection (CD) code to be used for CBRA initial access request. The CD code may be utilized to differentiate accessing UEs. The CD code may include of a string of N−1 bits of logic “0” and one bit of logic “1.” The CD code may include at least a row of the matrix

$$[ \begin{matrix}1 & 0 & 0 & 0 & Λ & 0 \\ 0 & 1 & 0 & 0 & Λ & 0 \\ 0 & 0 & 1 & 0 & Λ & 0 \\ 0 & 0 & 0 & 1 & Λ & 0 \\ M & M & M & M & O & M \\ 0 & 0 & 0 & 0 & Λ & 1\end{matrix} ] .$$

The CD code may include at least a row of the matrix

$$[ \begin{matrix}0 & 0 & 0 & 0 & Λ & 1 \\ 0 & 0 & 0 & 0 & Λ & 0 \\ 0 & 0 & 0 & 1 & Λ & 0 \\ 0 & 0 & 1 & 0 & Λ & 0 \\ M & M & M & M & O & M \\ 1 & 0 & 0 & 0 & Λ & 0\end{matrix} ] .$$

The CD code CBRA may be activated based on a specific service activation. A System Information broadcast (that may be sent and/or received) may indicate the support of CD code CBRA.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a gNB, a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio”, “New Radio Access Technology” or “NR” by 3GPP) envisions the use of time/frequency/space resources to allow for enhanced mobile broadband (eMBB) communication and ultra-reliable low-latency communication (URLLC) services, as well as massive machine type communication (mMTC) like services. In order for the services to use the time/frequency/space medium efficiently it would be useful to be able to flexibly schedule services on the medium so that the medium may be used as effectively as possible, given the conflicting needs of URLLC, eMBB, and mMTC. An NR base station may be referred to as a gNB. A gNB may also be more generally referred to as a base station device.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

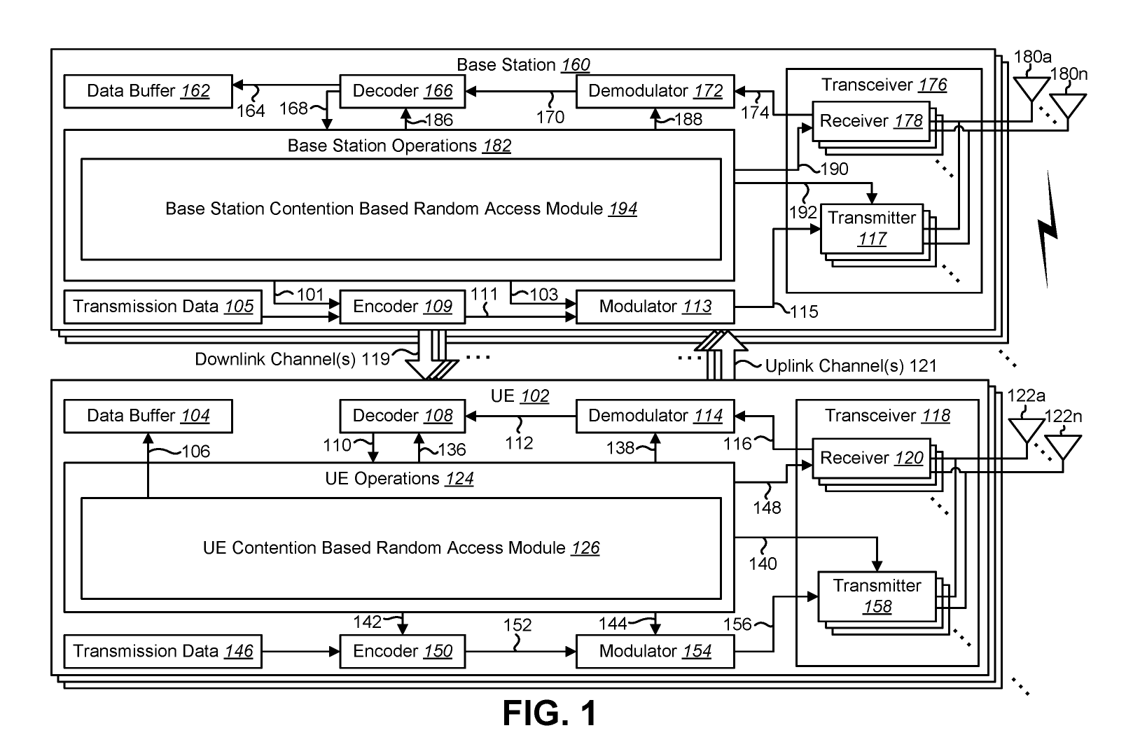

FIG. 1 is a block diagram illustrating one implementation of one or more base stations 160 (e.g., eNBs, gNBs, etc.) and one or more UEs 102 in which systems and methods for early collision detection in enhanced long term evolution (LTE)/5G New Radio (NR) random access may be implemented. The one or more UEs 102 communicate with one or more gNBs 160 using one or more physical antennas 122a-n. For example, a UE 102 transmits electromagnetic signals to the base station 160 (e.g., eNB, gNB, etc.) and receives electromagnetic signals from the base station 160 using the one or more physical antennas 122a-n. The base station 160 communicates with the UE 102 using one or more physical antennas 180a-n.

The UE 102 and the base station 160 may use one or more channels and/or one or more signals 119, 121 to communicate with each other. For example, the UE 102 may transmit information or data to the base station 160 using one or more uplink channels 121. Examples of uplink channels 121 include a physical shared channel (e.g., PUSCH (Physical Uplink Shared Channel)), and/or a physical control channel (e.g., PUCCH (Physical Uplink Control Channel)), etc. The one or more gNBs 160 may also transmit information or data to the one or more UEs 102 using one or more downlink channels 119, for instance. Examples of downlink channels 119 physical shared channel (e.g., PDSCH (Physical Downlink Shared Channel), and/or a physical control channel (PDCCH (Physical Downlink Control Channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the base station 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the base station 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE Contention Based Random Access (CBRA) module 126.

Some implementations of the systems and methods disclosed herein may provide a mechanism by which a base station (e.g., LTE-eNB, 5G NR-gNB, etc.) may determine with a high degree of reliability the occurrence of a collision between two or more UEs 102 during a first step of a random access (RA) procedure. The base station (e.g., LTE-eNB, 5G NR-gNB, etc.) may be able to determine a number of colliding UEs 102 using a special code (e.g., a collision detection (CD) code). Based on the CD code, the base station (e.g., LTE-eNB, 5G NR-gNB, etc.) may be able to allocate a number (e.g., a similar number) of grants to these colliding UEs. This approach may expedite the collision detection procedure in comparison with other approaches, where collision detection is performed by eNB/gNB base stations at a fourth stage (after receiving a message 4 for the colliding UEs, for example) of the RA process. For example, some approaches in accordance with the systems and methods disclosed herein may detect the collision at a first step (or after the first step, for example) instead, and/or may allow the base station 160 (e.g., eNB/gNB) to allocate an appropriate number of grants for colliding UEs. For instance, these approaches may avoid the allocation of a fixed number of grants in an RA-Response message (e.g., message 2), as in other approaches, which greatly impact the PRACH resources and hence the overall system capacity. In particular, a fixed allocation of grants may reduce the available resources by a factor of 2 or 3 for accessing UEs, depending on the number of grants allocated.

In some approaches, a collision detection (CD) code may include N bits. One of the N bits may have a value of 1, and the remainder of the N bits may have a value of 0 (e.g., one bit has a value of 1 and N−1 bits have a value of 0). For example, all of the bits may have a value of 0, but one digit may be set to 1. In some implementations, the CD code(s) may be expressed as an identity matrix, where each value along the main diagonal is 1 and all off-diagonal values are 0. For example, the N-bit CD code(s) may be presented in identity (e.g., I) matrix form as illustrated in Equation (1).

$$[ \begin{matrix}1 & 0 & 0 & 0 & Λ & 0 \\ 0 & 1 & 0 & 0 & Λ & 0 \\ 0 & 0 & 1 & 0 & Λ & 0 \\ 0 & 0 & 0 & 1 & Λ & 0 \\ M & M & M & M & O & M \\ 0 & 0 & 0 & 0 & Λ & 1\end{matrix} ] \qquad ( 1 )$$

Alternatively, the N-bit CD code(s) may be expressed as a matrix, where each value along the anti-diagonal is 1 and all other values are 0. For example, the N-bit CD code(s) may be presented as illustrated in Equation (2).

$$[ \begin{matrix}0 & 0 & 0 & 0 & Λ & 1 \\ 0 & 0 & 0 & 0 & Λ & 0 \\ 0 & 0 & 0 & 1 & Λ & 0 \\ 0 & 0 & 1 & 0 & Λ & 0 \\ M & M & M & M & O & M \\ 1 & 0 & 0 & 0 & Λ & 0\end{matrix} ] \qquad ( 2 )$$

In some approaches, each CD code may correspond to a row of a matrix (e.g., a row of the matrix in Equation (1) or a row of the matrix in Equation (2)).

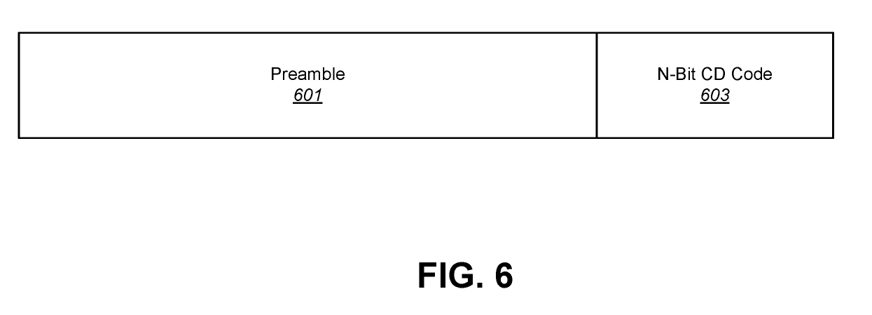

At the start of a CBRA procedure (e.g., CBRA RA procedure), accessing UEs 102 may randomly choose a pre-amble to send in message 1. In accordance with some approaches of the systems and methods disclosed herein, each UE 102 may also select one of the CD codes to be sent with the selected pre-amble. In some configurations, the UE may select a CD code randomly from the CD code space. In other configurations, the UE may select a CD code based on an identity that the UE possesses. For example, the UE may use a hash algorithm with IMSI (International Mobile Subscriber Identity) as an input to determine the CD code to select. An example of a structure for a pre-amble and an N-bit CD code is given in connection with FIG. 6.

This may reduce the probability of undetectable collision at stage 1 by a factor of N. Assuming that two UEs 102 are selecting the same pre-amble (at random) and selecting the same CD code (at random), for example, this probability may be expressed as given in Equation (3).

1/(M*N) (3)

In Equation (3), M is the number of pre-ambles used in the CBRA procedure (e.g., CBRA RA procedure) and N is the CD code size (N=2, 3, 4, . . . ). In this example, the base station (eNB/gNB) 160 may not be able to detect the collision at this stage. Otherwise (e.g., with a same pre-amble and different CD codes), the base station (eNB/gNB) 160 may receive two (for example) codes with a result of two “1s” codes, implying that at least two UEs are colliding.

In an example of 3 colliding UEs with different CD codes, there may be three “1s” at the receiving ends. The base station 160 may then allocate 2, 3, . . . , etc. different grants at the second stage, one for each colliding UE 102. The base station 160 may also associate each grant with a CD code so that each of the UEs 102 may select a corresponding (e.g., its own) grant based on its transmitted CD code. Alternatively, if the base station 160 did not include the associated CD codes, colliding UEs 102 may select their grant at random. This procedure may improve (e.g., significantly reduce) the delay in a random access process.

An example of a CBRA procedure (e.g., an enhanced CBRA procedure) in accordance with some approaches of the systems and methods disclosed herein is given as follows. At a first stage, a UE 102 may randomly select a preamble and a CD code. The UE 102 may send the random access preamble and the CD code to the base station (e.g., eNB, gNB, etc.) 160. The base station 160 may perform collision detection (e.g., may detect a collision) and/or may determine a number of UEs 102 (at the first stage or after a first stage, for example).

The base station 160 may perform contention resolution. For example, contention resolution may be performed at a second stage (after the first stage, for instance). In some alternative approaches, contention resolution may be performed at the first stage, during the first and second stages, or between the first and second stages. The base station 160 may allocate and/or send multiple grants. For example, the base station 160 may allocate a number of grants in a message 2 (Msg2) based on the number of “1” values (e.g., 1's) in the received CD codes. Each of the multiple grants may be sent with a CD code (e.g., a corresponding CD code). For example, the base station 160 may assign a CD code to each of the allocated grants. Each UE 102 may receive a grant based on a corresponding CD code (or may randomly select a grant, for example).

In some approaches, collision detection is done after step 1 (e.g., after a first stage). When two or more UEs 102 use same preamble with different CD codes, the base station 160 may receive the combination of the two. In this case, the base station 160 may detect the received CD code, which may be the combination of two different codes (with two “1” values in the code, for example). The base station 160 may determine that at least two UEs 102 are attempting access. In this case, the base station 160 may assign two grants and distinguish these with the different codes. For example, the base station 160 may receive 01000010 as CD code, which means that two codes (i.e., “01000000” and “00000010”) are used in the access attempt. Accordingly, the base station 160 may mark a first grant (e.g., grant 1) with “01000000” and a second grant (e.g., grant 2) with “00000010” for UE 102 distinction.

The UE 102 may receive multiple grants. For example, the UE 102 may receive multiple grants in a Random Access Response (e.g., message 2, Msg2, etc.).

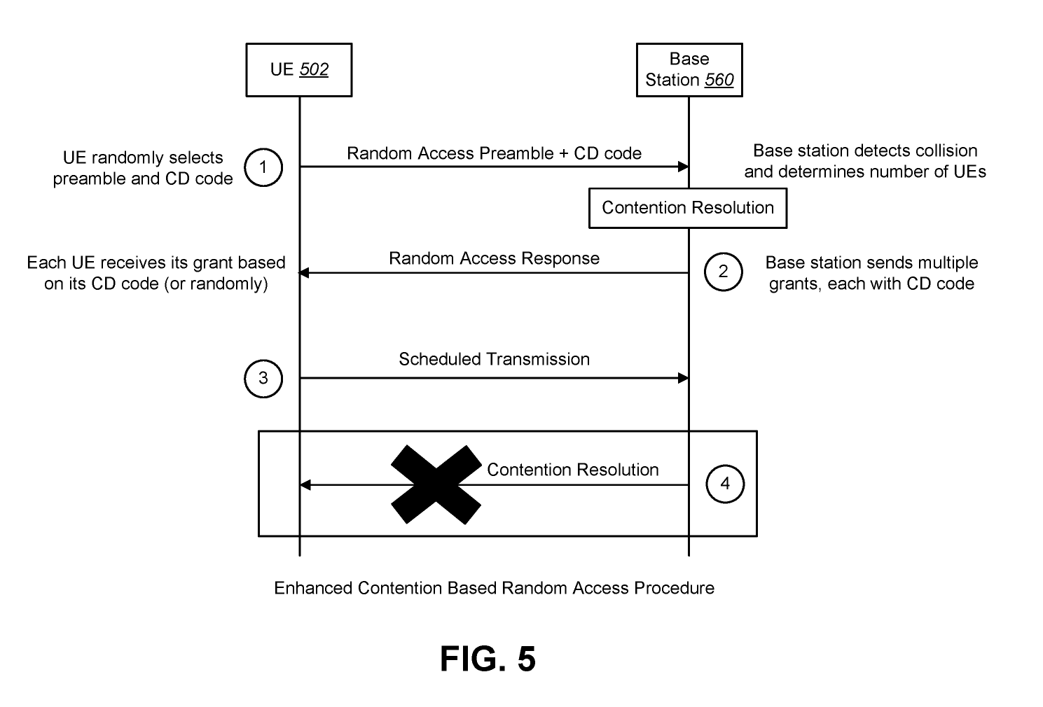

One or more scheduled transmissions may occur at a third stage (after the second stage, for example). An example of a CBRA is described in connection with FIG. 5. Some of the approaches of the systems and methods disclosed herein may be distinct from other approaches. For example, collision detection and/or contention resolution in some of the approaches described herein may be performed before a third stage (e.g., not at a fourth stage). For instance, collision detection and/or contention resolution may be performed before sending one or more grants. In other approaches, contention resolution may occur at a fourth stage (e.g., after grants and/or after data transmission by the UE(s) has been attempted).

In some approaches, the CBRA using CD code(s) may be used for all UEs 102 operating in a 5G NR service area, or the CBRA using CD code(s) may be activated for specific services with very limited delay requirements. In the restricted case where CBRA is activated for specific services, for example, when the UE 102 accesses a PRACH based on a specific service activation, the UE 102 may use the CD code, given that the network supports the feature. This feature may be indicated using System Information (SI) in some approaches. Additionally or alternatively, the UE 102 may indicate CD code usage while in the initial access.

In some approaches, an error case may occur when the accessing UE 102 does not recognize any of the received CD code(s) (which is associated with a grant in the Msg2, for example), as its selected and transmitted code. This may cause the UE 102 to determine that the access attempt has failed. In case of a failed attempt, the UE 102 may perform back-off procedures (e.g., selecting back-off random delay) and may re-attempt the CBRA procedures as in described in connection with FIG. 5.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160. For instance, the one or more transmitters 158 may transmit during an uplink (UL) subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a base station operations module 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the base station operations module 182 to perform one or more operations.

In general, the base station (e.g., eNB, gNB, etc.) operations module 182 may enable the base station 160 to communicate with the one or more UEs 102. The base station operations module 182 may include one or more of a base station (e.g., gNB) Contention Based Random Access (CBRA) module 194. The base station CBRA module 194 may perform one or more CBRA operations as described herein.

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode information 101, including transmission data 105.

The encoder 109 may encode transmission data 105 and/or other information included in the information 101 provided by the base station operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a downlink (DL) subframe may be transmitted from the base station 160 to one or more UEs 102 and that a UL subframe may be transmitted from one or more UEs 102 to the base station 160. Furthermore, both the base station 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

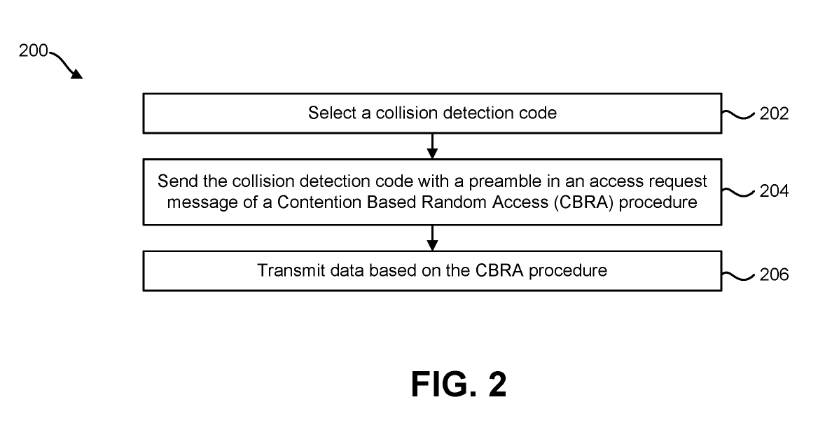

FIG. 2 is a flow diagram illustrating an example of a method 200 for performing a contention-based random access (CBRA) procedure by a UE 102. For example, the method 200 may be performed by one or more UEs 102 described in connection with FIG. 1.

A UE 102 may select 202 a collision detection code. This may be performed as described in connection with FIG. 1.

The UE 102 may send 204 the collision detection code with a preamble in an access request message of the CBRA procedure (e.g., at a first stage, in a message 1, etc.). This may be performed as described in connection with FIG. 1.

The UE 102 may transmit 206 data based on the CBRA procedure. This may be performed as described in connection with FIG. 1. For example, the UE 102 may receive a grant with a collision detection code corresponding to the collision detection code sent. In another approach, the UE 102 may receive multiple grants and may randomly select a grant. In some approaches, the UE may receive multiple grants in a Random Access Response (e.g., message 2, Msg2, etc.). The UE 102 may transmit data in accordance with the grant.

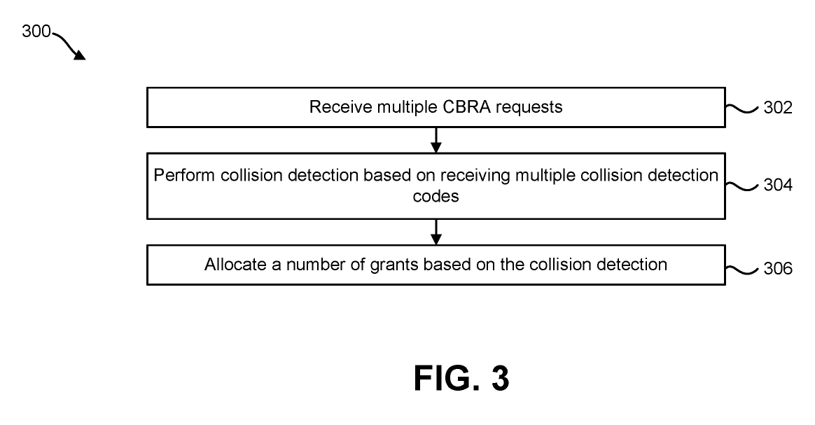

FIG. 3 is a flow diagram illustrating an example of a method 300 for performing a contention-based random access (CBRA) procedure by a base station 160. For example, the method 300 may be performed by the base station 160 described in connection with FIG. 1.

A base station 160 may receive 302 multiple CBRA requests. This may be performed as described in connection with FIG. 1. For example, the base station 160 may receive multiple random access requests associated with multiple CD codes (from multiple UEs 102, for instance). The base station 160 may receive 302 the multiple CBRA requests at a first step (e.g., step 1, first stage, etc.).

The base station 160 may perform 304 collision detection based on receiving multiple CD codes. This may be performed as described in connection with FIG. 1. For example, the base station 160 may detect a collision based on receiving multiple CD codes associated with a single preamble.

The base station 160 may allocate 306 a number of grants based on the collision detection. This may be performed as described in connection with FIG. 1. For example, the base station 160 may send a number of grants based on a number of UEs 102 (e.g., collisions) detected. In some approaches, the grants may include CD codes corresponding to the received CD codes for the UEs 102.

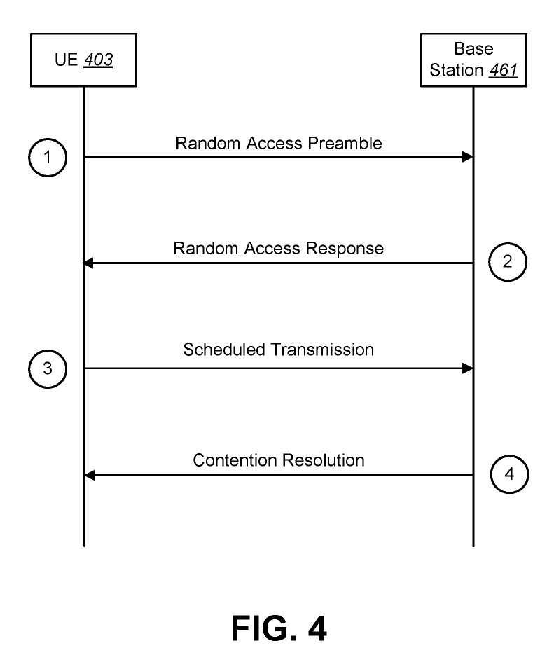

FIG. 4 is a diagram illustrating an example of a contention-based random access procedure. A UE 403 may communicate with a base station 461 (e.g., eNB, gNB, etc.). The contention-based random access procedures may include the following steps (e.g., four steps, four stages, etc.).

A first step (1) includes a random access preamble on Random Access Channel (RACH) in uplink. There are two possible groups defined and one is optional. If both groups are configured, the size of message 3 and the path loss are used to determine which group a preamble is selected from. The group to which a preamble belongs provides an indication of the size of the message 3 and the radio conditions at the UE 403. The preamble group information along with the necessary thresholds are broadcast on system information. In this example, the physical layer random access burst may include a cyclic prefix, a preamble, and a guard time during which nothing is transmitted. The random access preambles may be generated from Zadoff-Chu sequences with zero correlation zone, Zadoff-Chu Zero Correlation Zone (ZC-ZCZ), generated from one or several root Zadoff-Chu sequences.

A second step (2) includes a random access response generated by Medium Access Control (MAC) on DownLink Shared Channel (DL-SCH). This step is semi-synchronous (within a flexible window of which the size is one or more TTI) with message 1. In this case, there is no HARQ. The random access response may be addressed to RA-RNTI on PDCCH. The random access response conveys at least a RA-preamble identifier, timing alignment information for the pTAG, one or more initial UL grants and assignment of Temporary C-RNTI (which may or may not be made permanent upon contention resolution). In some approaches, an optional collision detection code may be utilized for each initial UL grant. The random access response may be intended for a variable number of UEs in one DL-SCH message.

A third step (3) includes a first scheduled UL transmission on an UpLink Shared Channel (UL-SCH). The scheduled transmission uses HARQ. The size of the transport blocks depends on the UL grant conveyed in step 2. For initial access, the scheduled transmission conveys the RRC connection request generated by the RRC layer and transmitted via Common Control Channel (CCCH). The scheduled transmission conveys at least Non-Access Stratum (NAS) UE identifier but no NAS message. The Radio Link Control (RLC) Transparent Mode (TM) has no segmentation.

For an Radio Resource Control (RRC) connection re-establishment procedure, the scheduled transmission conveys the RRC connection re-establishment request generated by the RRC layer and transmitted via CCCH. The RLC TM has no segmentation. The scheduled transmission does not contain any NAS message.

After handover, in the target cell, the scheduled transmission conveys the ciphered and integrity protected RRC Handover Confirm generated by the RRC layer and transmitted via Dedicated Control Channel (DCCH). The scheduled transmission conveys the C-RNTI of the UE (which was allocated via the Handover Command) The scheduled transmission includes an uplink Buffer Status Report when possible. For other events, the scheduled transmission conveys at least the C-RNTI of the UE.

For NB-IoT, in the procedure to resume the RRC connection, the scheduled transmission conveys a Resume ID to resume the RRC connection. In the procedure to setup the RRC connection, an indication of the amount of data for subsequent transmission(s) on a Signaling Radio Bearer (SRB) or Data Radio Bearer (DRB) can be indicated. A fourth step (4) includes contention resolution on DL.

FIG. 5 is a diagram illustrating an example of a Contention Based Random Access (CBRA) procedure (e.g., an enhanced CBRA procedure) in accordance with some approaches of the systems and methods disclosed herein. One or more of the steps and/or stages of the CBRA described in connection with FIG. 5 may include one or more aspects described in connection with FIG. 4.

At a first stage, a UE 502 may randomly select a preamble and a CD code. The UE 502 may send the random access preamble and the CD code to the base station (e.g., eNB, gNB, etc.) 560. In some approaches, the collision detection code may be sent with a preamble in a message 1 (e.g., Msg1) of CBRA procedure(s). The base station 560 may perform collision detection (e.g., may detect one or more collisions) and/or may determine a number of UEs 502.

The base station 560 may perform contention resolution. For example, contention resolution may be performed at a second stage (after the first stage, for instance). In some alternative approaches, contention resolution may be performed at the first stage, during the first and second stages, or between the first and second stages.

At the second stage, the base station 560 may allocate and/or send a random access response and/or multiple grants. For example, the number of grants may be based on (e.g., may correspond to) the number of UE collisions (e.g., the number of “1” values in the CD codes). Each of the multiple grants may be sent with a CD code (e.g., a CD code for each grant corresponding to the CD codes received with the random access preambles). Each UE 502 may receive a grant based on a corresponding CD code (or may randomly select a grant, for example). In some approaches, a CD code may not be sent and the UE 502 may randomly select one of the grants for transmission.

One or more scheduled transmissions may occur at a third stage (after the second stage, for example). Some of the approaches of the systems and methods disclosed herein may be distinct from other approaches. For example, collision detection and/or contention resolution in some of the approaches described herein may be performed before a third stage and/or may not be performed at a fourth stage, as illustrated in FIG. 5.

FIG. 6 is an example of a message structure that may be utilized in some implementations of the systems and methods disclosed herein. For instance, a UE 102 may send an N-bit CD code 603 with a preamble 601 to a base station 160. This may be accomplished as described in connection with FIG. 1.

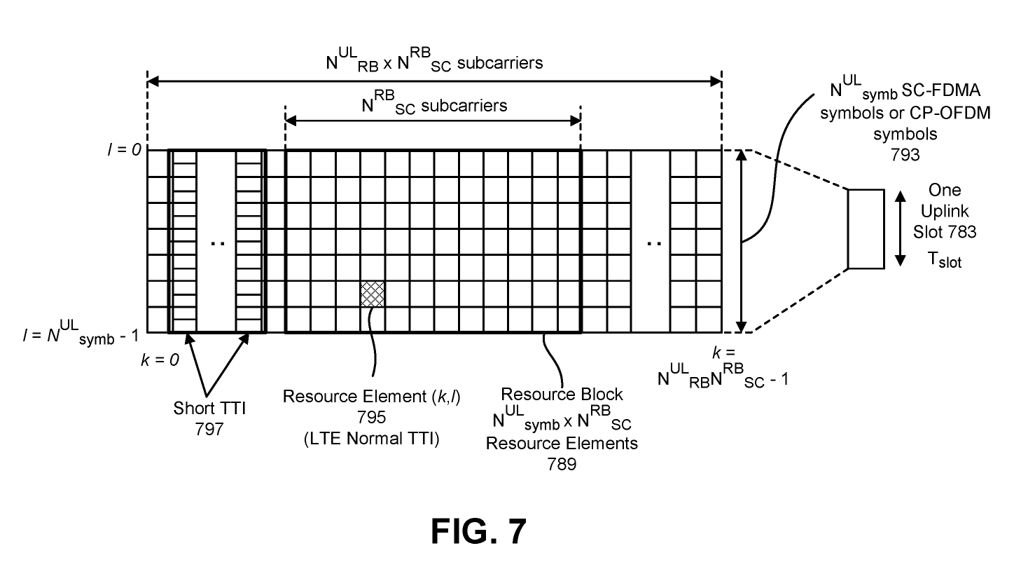

FIG. 7 is a diagram illustrating one example of a resource grid for the uplink. The resource grid illustrated in FIG. 7 may be utilized in some implementations of the systems and methods disclosed herein. More detail regarding the resource grid is given in connection with FIG. 1.

In FIG. 7, one uplink subframe may include two uplink slots 783. N^{UL}_{RB} is uplink bandwidth configuration of the serving cell, expressed in multiples of N^{RB}_{sc}, where N^{RB}_{sc} is a resource block 789 size in the frequency domain expressed as a number of subcarriers, and N^{UL}_{symb} is the number of SC-FDMA or CP-OFDM symbols 793 in an uplink slot 783. A resource block 789 may include a number of resource elements (RE) 791.

In LTE, a resource block 789 may be a normal Transmission Time Interval (TTI) 795. In NR, a short TTI 797 may be a number of resource elements 789 or sub-units of resource elements 789. The length of a short TTI 797 may be less than a normal TTI 795.

For a PCell, N^{UL}_{RB} is broadcast as a part of system information. For an SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PUSCH, PRACH and the like may be transmitted. An uplink radio frame may include multiple pairs of uplink resource blocks. The uplink resource block (RB) pair is a unit for assigning uplink radio resources, defined by a predetermined bandwidth (RB bandwidth) and a time slot. The uplink RB pair may include two uplink RBs that are continuous in the time domain.

The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) and is uniquely identified by the index pair (k,l) in a slot, where k and l are indices in the frequency and time domains respectively. While uplink subframes in one component carrier (CC) are discussed herein, uplink subframes are defined for each CC.

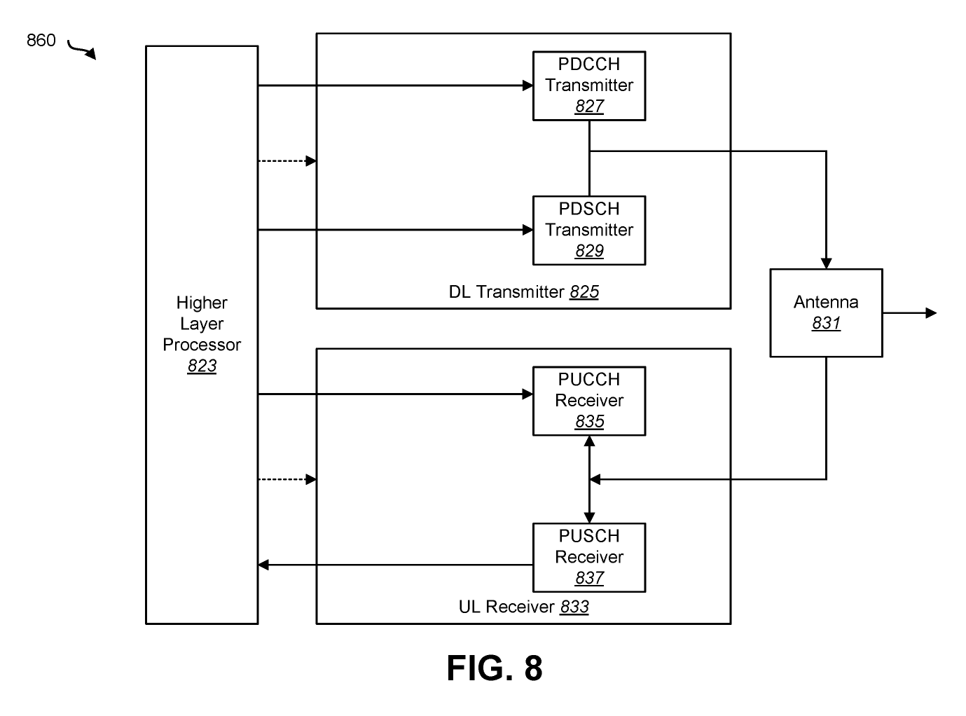

FIG. 8 is a block diagram illustrating one implementation of a base station 860 (e.g., eNB, gNB). The base station 860 may include a higher layer processor 823, a DL transmitter 825, a UL receiver 833, and one or more antenna 831. The DL transmitter 825 may include a PDCCH transmitter 827 and a PDSCH transmitter 829. The UL receiver 833 may include a PUCCH receiver 835 and a PUSCH receiver 837.

The higher layer processor 823 may manage physical layer's behaviors (the DL transmitter's and the UL receiver's behaviors) and provide higher layer parameters to the physical layer. The higher layer processor 823 may obtain transport blocks from the physical layer. The higher layer processor 823 may send/acquire higher layer messages such as an RRC message and MAC message to/from a UE's higher layer. The higher layer processor 823 may provide the PDSCH transmitter transport blocks and provide the PDCCH transmitter transmission parameters related to the transport blocks.

The DL transmitter 825 may multiplex downlink physical channels and downlink physical signals (including reservation signal) and transmit them via transmission antennas 831. The UL receiver 833 may receive multiplexed uplink physical channels and uplink physical signals via receiving antennas 831 and de-multiplex them. The PUCCH receiver 835 may provide the higher layer processor 823 Uplink Control Information (UCI). The PUSCH receiver 837 may provide the higher layer processor 823 received transport blocks.

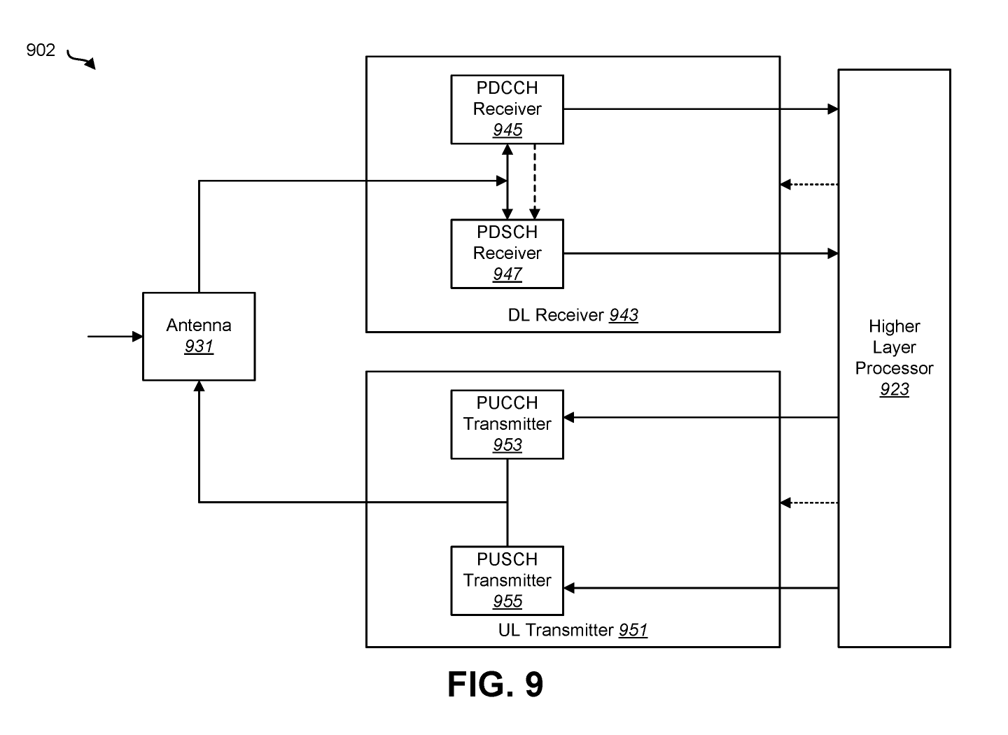

FIG. 9 is a block diagram illustrating one implementation of a UE 902. The UE 902 may include a higher layer processor 923, a UL transmitter 951, a DL receiver 943, and one or more antenna 931. The UL transmitter 951 may include a PUCCH transmitter 953 and a PUSCH transmitter 955. The DL receiver 943 may include a PDCCH receiver 945 and a PDSCH receiver 947.

The higher layer processor 923 may manage physical layer's behaviors (the UL transmitter's and the DL receiver's behaviors) and provide higher layer parameters to the physical layer. The higher layer processor 923 may obtain transport blocks from the physical layer. The higher layer processor 923 may send/acquire higher layer messages such as an RRC message and MAC message to/from a UE's higher layer. The higher layer processor 923 may provide the PUSCH transmitter transport blocks and provide the PUCCH transmitter 953 UCI.

The DL receiver 943 may receive multiplexed downlink physical channels and downlink physical signals via receiving antennas 931 and de-multiplex them. The PDCCH receiver 945 may provide the higher layer processor 923 Downlink Control Information (DCI). The PDSCH receiver 947 may provide the higher layer processor 923 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

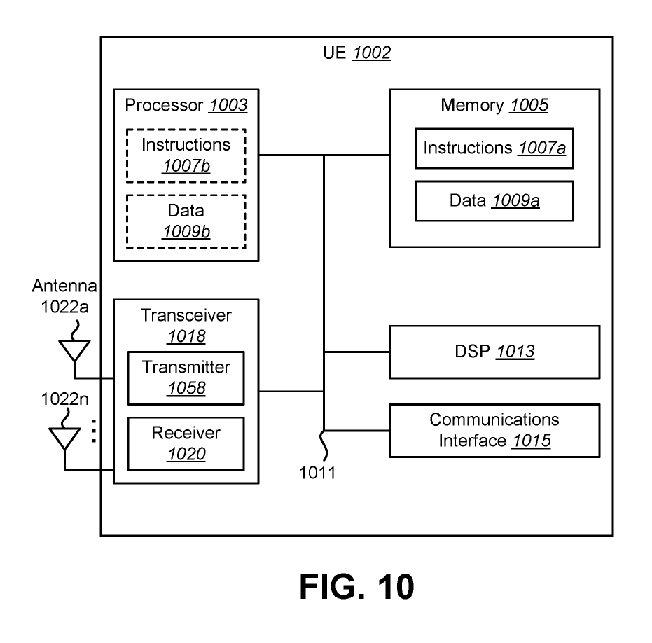

FIG. 10 illustrates various components that may be utilized in a UE 1002. The UE 1002 described in connection with FIG. 10 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement one or more of the methods described above.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 10 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 10 is a functional block diagram rather than a listing of specific components.

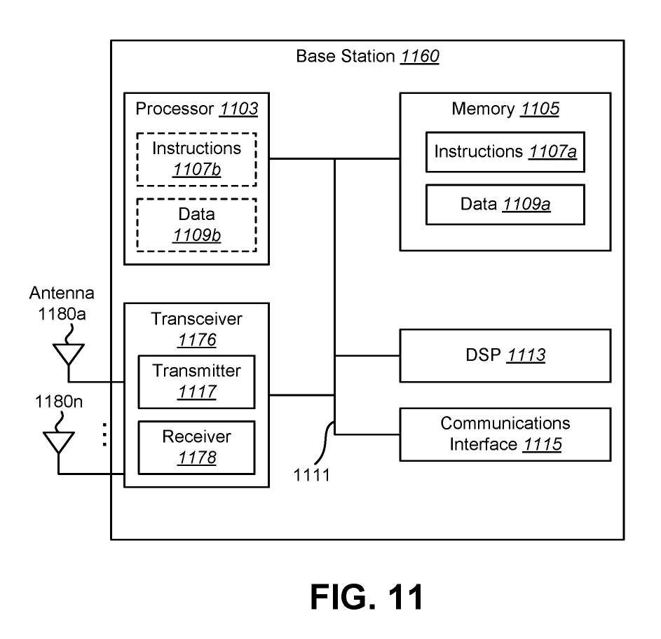

FIG. 11 illustrates various components that may be utilized in a base station 1160 (e.g., eNB, gNB, etc.). The base station 1160 described in connection with FIG. 11 may be implemented in accordance with the base station 160 described in connection with FIG. 1. The base station 1160 includes a processor 1103 that controls operation of the base station 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include non-volatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement one or more of the methods described above.

The base station 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the base station 1160 are coupled together by a bus system 1111, which may include a power bus, a control signal bus and a status signal bus, in addition to a data bus. However, for the sake of clarity, the various buses are illustrated in FIG. 11 as the bus system 1111. The base station 1160 may also include a digital signal processor (DSP) 1113 for use in processing signals. The base station 1160 may also include a communications interface 1115 that provides user access to the functions of the base station 1160. The base station 1160 illustrated in FIG. 11 is a functional block diagram rather than a listing of specific components.

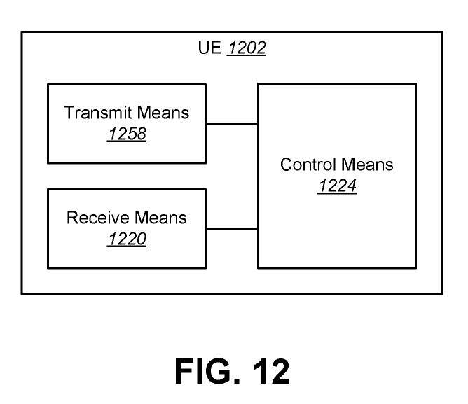

FIG. 12 is a block diagram illustrating one implementation of a UE 1202 in which systems and methods for collision based random access may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 10 above illustrates one example of a concrete apparatus structure of FIG. 12. Other various structures may be implemented to realize one or more of the functions of FIG. 1. For example, a DSP may be realized by software.

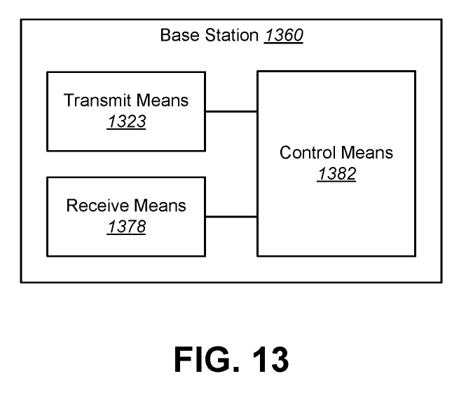

FIG. 13 is a block diagram illustrating one implementation of a base station 1360 (e.g., eNB, gNB, etc.) in which systems and methods for collision based random access may be implemented. The base station 1360 includes transmit means 1317, receive means 1378 and control means 1382. The transmit means 1317, receive means 1378 and control means 1382 may be configured to perform one or more of the functions described in connection with FIG. 1 above. FIG. 11 above illustrates one example of a concrete apparatus structure of FIG. 13. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the base station 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the base station 160 and the UE 102 according to the systems and methods described above may be realized as an LSI that is a typical integrated circuit. Each functional block of the base station 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A base station, comprising:
a processor; and
memory in electronic communication with the processor, wherein instructions stored in the memory are executable to:
receive multiple Contention Based Random Access (CBRA) requests on a Physical Random Access Channel (PRACH); and
detect a collision based on the receiving of multiple collision detection (CD) codes associated with a single preamble.

2. The base station of claim 1, wherein the multiple CBRA requests are received in message 1s (Msg1s).

3. The base station of claim 1, wherein the instructions are further executable to determine a number of colliding user equipments (UEs) based on a number of 1's values in the CD codes received in the multiple CBRA requests.

4. The base station of claim 3, wherein the instructions are further executable to allocate a number of grants in a message 2 (Msg2) based on the number of 1's values in the CD codes.

5. The base station of claim 4, wherein the instructions are further executable to assign the received CD codes to allocated grants.

6. The base station of claim 4, wherein the instructions are further executable to allocate grants without assigning associated CD codes for each grant.

7. The base station of claim 1, wherein the base station is an evolved Node B (eNB) or a 5G new radio (NR) gNB.

8. A user equipment (UE), comprising:
a processor; and
memory in electronic communication with the processor, wherein instructions stored in the memory are executable to:
send a collision detection (CD) code with a preamble in an access request message of a Contention Based Random Access (CBRA) procedure.

9. The UE of claim 8, wherein the CD code is sent in a CBRA request (message 1).

10. The UE of claim 8, wherein the instructions are executable to:
randomly select a preamble; and
randomly select the CD code to be transmitted in a CBRA request.

11. The UE of claim 8, wherein the instructions are executable to:
receive multiple grants in a Random Access Response (message 2); and
randomly select one of the multiple grants if there is no associated CD code present.

12. The UE of claim 8, wherein the instructions are executable to:
receive multiple grants in a Random Access Response (message 2), wherein each grant is associated with a CD code that has been received by a base station in a CBRA request;
select a grant that is associated with a CD code that was sent by the UE in the CBRA request; and
use resources provided in a received grant to send a message 3.

13. A method to perform collision detection by a base station in a Contention Based Random Access (CBRA) procedure, comprising:
performing collision detection at a first stage (stage 1) based on a received combination of collision detection (CD) codes sent by colliding UEs;
determining a number of colliding user equipments (UEs) based on a number of 1's in the received CD code; and
allocating a corresponding number of grants based on the determination of the number of colliding UEs.

14. A method for indicating collision detection by a user equipment (UE) in a Contention Based Random Access (CBRA), comprising:
randomly selecting a collision detection (CD) code to be transmitted with a randomly selected preamble in a CBRA request (message 1);
receiving multiple grants in a Random Access Response (message 2), wherein each grant is associated with a CD code, and wherein one of the CD codes corresponds to the CD code that has been sent in the CBRA request; and
selecting a grant that is associated with the CD code that was sent by the UE in the CBRA request; and
using the grant in sending a message 3.

15. The method of claim 14, wherein a CBRA based access code comprises a combination of a randomly selected preamble and a randomly selected collision detection (CD) code to be used for CBRA initial access request.

16. The method of claim 14, wherein the CD code is utilized to differentiate accessing UEs, and wherein the CD code comprises of a string of N−1 bits of logic “0” and one bit of logic “1.”

17. The method of claim 14, wherein the CD code comprises at least a row of a matrix
$$[ \begin{matrix}1 & 0 & 0 & 0 & Λ & 0 \\ 0 & 1 & 0 & 0 & Λ & 0 \\ 0 & 0 & 1 & 0 & Λ & 0 \\ 0 & 0 & 0 & 1 & Λ & 0 \\ M & M & M & M & O & M \\ 0 & 0 & 0 & 0 & Λ & 1\end{matrix} ] .$$

18. The method of claim 14, wherein the CD code comprises at least a row of a matrix
$$[ \begin{matrix}0 & 0 & 0 & 0 & Λ & 1 \\ 0 & 0 & 0 & 0 & Λ & 0 \\ 0 & 0 & 0 & 1 & Λ & 0 \\ 0 & 0 & 1 & 0 & Λ & 0 \\ M & M & M & M & O & M \\ 1 & 0 & 0 & 0 & Λ & 0\end{matrix} ] .$$

19. The method of claim 14, further comprising activating the CD code CBRA based on a specific service activation.

20. The method of claim 14, further comprising receiving a System Information broadcast indicating support of CD code CBRA.
